(19) United States
(12) Patent Application Publication
(10) Pub. No.: US 2025/0268251 A1
(43) Pub. Date: Aug. 28, 2025

(54) AGROCHEMICAL COMPOSITIONS COMPRISING A WETTING AGENT

(71) Applicant: ADAMA MAKHTESHIM LTD., Beer Sheva (IL)

(72) Inventors: Yossef PERETZ, Beer-Sheva (IL); Yogev DAHAN, Tene Omarim (IL)

(73) Assignee: ADAMA MAKHTESHIM LTD., Beer Sheva (IL)

(21) Appl. No.: 18/570,370

(22) PCT Filed: Jun. 21, 2022
(86) PCT No.: PCT/IL2022/050666

§ 371 Date: Dec. 14, 2023

Related U.S. Application Data
(60) Provisional application No. 63/213,235, filed on Jun. 22, 2021.

(51) Int. Cl. A01N 25/30; A01N 25/04; A01N 25/10; A01N 43/56; A01N 47/34; A01P 7/04

(52) U.S. Cl. CPC A01N 25/30; A01N 25/04; A01N 25/10; A01N 43/56; A01N 47/34; A01P 7/04

(57) ABSTRACT

The present invention relates to agricultural formulations exhibiting enhanced wetting properties, in particular, agricultural formulations comprising alcohol ethoxylates as wetting agents for benzoyl urea insecticides. The present invention further provides a method for pests control comprising the same.

### CROSS-REFERENCE TO RELATED APPLICATIONS

This application is a U.S. National Stage Application, filed under 35 U.S.C. § 371, of International Application No. PCT/IL2022/050666, filed Jun. 21, 2022, which claims the benefit of U.S. Provisional Application No. 63/213,235, filed Jun. 22, 2021, the entire contents of which are incorporated by reference herein.

### FIELD OF THE INVENTION

The present invention relates to aqueous agricultural formulations exhibiting enhanced wetting properties. In particular, the invention relates to the use of certain alcohol ethoxylates as wetting agents for benzoyl urea insecticides and their mixtures with anthranilamides.

### SUMMARY

The present invention therefore provides an agrochemical composition comprising: a) benzoyl urea insecticidal compound selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from ethoxylated alcohols of formula (II) and/or (IIa)

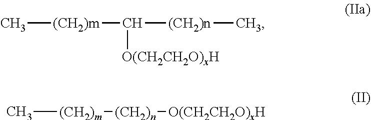

wherein 5≤x≤10, 6≤n+m≤13; and c) optionally, an additive.

In addition, the present invention is referred to an agrochemical composition comprising: a) benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from alcohol ethoxylates of formula (II) and/or (IIa); c) optionally, an additive; d) chlorantraniliprole.

The present invention further provides an agrochemical composition comprising: a) benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from alcohol ethoxylates of formula (II) and/or (IIa); c) optionally, an additive; d) cyantraniliprole.

In some embodiments the present invention provides an agrochemical composition comprising: a) novaluron; b) wetting agent selected from alcohol alkoxylates of formula (II) and/or (IIa); c) optionally, an additive; d) chlorantraniliprole.

In addition, the present invention is referred to an agrochemical composition comprising: a) 1.0% to 30% w/w of novaluron; b) 0.5% to 4.0% w/w of wetting agent selected from alcohol alkoxylates of formula (II) and/or (IIa); c) 1.0% to 4.0% of dispersant selected from polyacrylates, grafted polymethylmethacrylates and/or ethoxylated tristypylphenol sulfonates; d) 0.5% to 1.5% w/w of stabilizer selected from the group consisting of magnesium aluminum silicate, montmorillonite, smectite clay and the mixtures thereof; e) 2.0% to 30% w/w of chlorantraniliprole.

The present invention further provides a method which comprises stabilizing the suspension state of benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof a) by means of b) wetting agent selected from alcohol alkoxylates of formula (II) and/or (IIa).

The present invention further provides a method for controlling pests by applying to a pest or the locus of said pest of the agrochemical composition comprising: a) benzoyl urea insecticidal compound selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from ethoxylated alcohols of formula (II) and/or (IIa)

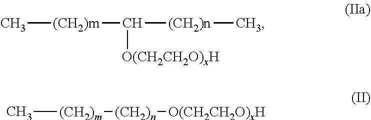

wherein 5≤x≤10, 6≤n+m≤13; and c) optionally, an additive

The present invention further provides a method for the protection of plant propagation material from the attack by a pest such as an insect, comprising treating the propagation material or the site where the propagation material is to be planted with an effective amount of the agrochemical composition comprising: a) benzoyl urea insecticidal compound selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from ethoxylated alcohols of formula (II) and/or (IIa)

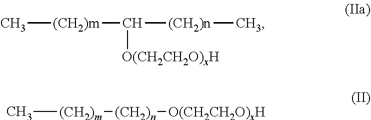

wherein 5≤x≤10, 6≤n+m≤13; and c) optionally, an additive

### BACKGROUND

Pesticides in the form of emulsifiable concentrates or soluble liquids in which the solid active ingredient is dissolved are preferred by the user since they are easy to handle, measure and mix under field conditions. In addition, in most cases, the dissolved pesticides tends to show high efficacy on the field of application, however, the greatest disadvantage of said compositions containing dissolved pesticides is of being based on high content of an organic, mostly aromatic solvents, or other heavy organic solvent systems and thus unfavorable on toxicological and environmental grounds. This problem can be overcome by formulating the pesticide as a water-based suspension or granular flowable formulations which consist of finely divided water-insoluble particles of pesticides suspended in water. On the other hand, some pesticides are solids which are difficult to stabilize in the dispersed phase due to their low wetting properties.

Particularly, novaluron, belonging to a group of benzoyl urea insecticides appears as solid powder with extremely low wetting properties. Wetting of novaluron with commonly used wetting agents is not sufficient/Partial, extremely slow and problematic; therefore, agrochemical composition containing suspended novaluron are rare. In general, higher amounts of wetting agents in the agrochemical compositions lead to sedimentations and low formulation stability. In addition, the composition with improved wetting properties, in some instances increases the formulation effectiveness through enhanced contact, better penetration and lower surface tension of total composition. Improved wettability lead to enhanced foliage adhesion with which the pesticide will able to stay longer on leaves or other essential parts of the plant. Consequently, the search continues for wetting agents which provide high formulation stability and enhanced pesticide activity via improved wetting effectiveness.

### BRIEF DESCRIPTION OF THE FIGURES

FIG. 1. Contact angle values with parafilm surface as a function of time for different concentration of wetter solutions' containing Tergitol™ 15-s-7.

FIG. 2. Contact angle values with parafilm surface as a function of time for different concentration of wetter solutions' containing Emcol 4500™.

FIG. 3. Initial contact angles of water solutions of Emcol 4500™ and Tergitol™ 15-s-7 at different concentrations. Initial value of droplet contact angle was calculated by the average of the three measurements.

FIG. 4. Final contact angles of water solutions of Emcol 4500™ and Tergitol™ 15-s-7 at different concentrations. Final value of droplet contact angle was calculated by the average of the three measurements.

FIG. 5. Initial spreading rate of water solutions of Emcol 4500™ and Tergitol™ 15-s-7 at different concentrations. Initial rate of droplet spreading was calculated by the average of the first ten values of time derivative of the droplet angle.

### DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

The term “a” or “an” as used herein includes the singular and the plural, unless specifically stated otherwise. Therefore, the terms “a,” “an,” or “at least one” can be used interchangeably in this application.

Throughout the application, descriptions of various embodiments use the term “comprising”; however, it will be understood by one skilled in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages, or proportions, and other numerical values used in the specification and claims, are to be understood as being modified in all instances by the term “about.”

Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

As used herein, the term “insecticide” broadly refers to compounds or compositions that are used as acaricides, insecticides, insecticide synergists, ixodicides, nematicides, and molluscicides. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein the term “plant” or “crop” refers, but is not limited to whole plants, plant organs (e.g. leaves, stems, twigs, roots, trunks, limbs, shoots, fruits etc.), plant cells, or plant seeds. This term also encompasses plant crops such as fruits and vegetables. In some embodiments, the term “plant” may include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein the term “plant propagation material” refers, but is not limited to all the generative parts of the plant such as seeds and vegetative plant material such as cuttings and tubers, which can be used for the multiplication of the plant including tubers, spores, corms, bulbs, rhizomes, sprouts basal shoots, stolons, and buds and other parts of plants, including seedlings and young plants, which are to be transplanted after germination or after emergence from soil.

As used herein, the term “locus” refers, but is not limited to the place on which the plants are growing, the place on which the plant propagation materials of the plants are sown or the place on which the plant propagation materials of the plants will be sown including the areas under cultivation.

As used herein, the term “dilution” refers, but is not limited to wetting the composition.

As used herein, the term “mixture” or “combination” refers, but is not limited to, a combination in any physical form, e.g., blend, solution, suspension or the like.

### The Agrochemical Composition Subject of Invention:

The present invention provides an agrochemical composition comprising: a) benzoyl urea insecticidal compound selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from ethoxylated alcohols of formula (II) and/or (IIa)

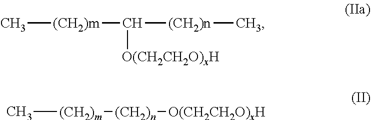

wherein 5≤x≤10, 6≤n+m≤13; and c) optionally, an additive.

In an embodiment the amount of wetting agent (b) is from 0.5% to 4.0% by weight of total composition.

In a class of this embodiment the amount of wetting agent (b) is from 0.5% to 4% by weight of total composition.

In an embodiment the ratio of wetting agent b) to the benzoyl urea compound a) of formula (I) is from 1:24 to 1:3.

In an embodiment the wetting agent b) is selected from the group comprising C₈-C₁₄ secondary alcohol ethoxylates having 5-10 ethylene oxide units.

In another embodiment the wetting agent b) is selected from the group comprising C₈-C₁₄ primary alcohol ethoxylates having 5-10 ethylene oxide units.

In certain embodiment the benzoyl urea a) is novaluron.

In an embodiment the benzoyl urea a) is novaluron and the wetting agent b) is selected from the group comprising C₈-C₁₄ secondary alcohol ethoxylates having 5-10 ethylene oxide units.

In an embodiment the agrochemical composition comprises: a) benzoyl urea insecticidal compound selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from ethoxylated alcohols of formula (II) and/or (IIa)

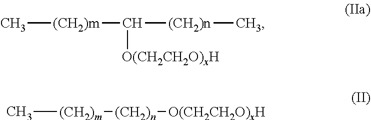

wherein 5≤x≤10, 6≤n+m≤13; and c) an additive.

In the class of this embodiment, the additive is at least one member selected from the group consisting of an antifreezing agent, a thickener, an antifoaming agent, a dispersant, a surfactant, a pH modifier and a stabilizer.

The term “additive” as used herein refers but not limited to a chemical agent that is added to a composition and selected from the group consisting of an antifreezing agent, a thickener, an antifoaming agent, a dispersant, a surfactant, a pH modifier and a stabilizer.

The term “dispersant” as used herein refers but not limited to chemical agent added to a composition to prevent flocculation, i.e., to prevent solid particles from sticking together and forming larger agglomerations of particles a chemical agent that is added to a composition and selected from the group consisting of anionic polymeric dispersants, lignosulfonates, alkyl formaldehyde condensates, non-ionic polymeric dispersants, polyvinyl alcohols, acrylic copolymers, and acrylic comb dispersant.

The term “pH modifier” as used herein refers but not limited to a chemical agent that is added to a composition so as to ensure that pH level is optimal to maximize the composition efficacy and selected from selected from organic and inorganic components such as acids, bases, buffers and the like. In a non-limiting embodiment, the pH modifier may be selected from hydrochloric Acid, citric acid, acetic acid, potassium carbonate, potassium hydroxide, sodium hydroxide and sodium dihydrogen phosphate. However, the choice of a pH modifier is not particularly limiting. The pH modifier is present in an amount of 0.1-2.0% w/w.

The term “stabilizer” as used herein refers but not limited to a chemical agent that is added to a composition and exhibiting a satisfactory stabilization effect on the combination of other inert and active ingredient/s contained in the present agricultural chemical composition, without any adverse influence on the physical properties of the composition.

The stabilizing agent of the composition of the present invention comprises an inorganic, typically aluminosilicate or magnesium silicate, colloid-forming clay, typically, a smectite clay, an attapulgite clay, or a mixture thereof. These clay materials can be described as expandable layered clays, wherein the term “expandable” as used herein in reference to such clay relates to the ability of the layered clay structure to be swollen, or expanded, on contact with water.

The term “thickener” as used herein refers but not limited to a chemical agent that is added to a composition which may increase viscosity, change consistency, stabilize and/or facilitate suspending of the active particles within the liquid mixture. Thickener as used herein can be selected from the group comprising of xanthan gum, carboxymethylcellulose, hydroxyethylcellulose, dextrine, gum arabica, silica, fumed silica, inorganic colloidal or colloid-forming particles, clays, and synthetic polymeric thickeners such as polyvinyl alcohol or mixtures thereof. Thickener can be used in the range of 0.04% to 0.4% of the formulation. In one embodiment, the thickener as used herein can be xanthan gum.

The term “antifreezing agent” as used herein refers but not limited to a chemical agent that is added to a composition and lowers the freezing point of a composition. Anti-freezing agent as used herein can be selected from the group comprising of polyethylene glycols, methoxypolyethylene glycols, polypropylene glycols, polybutylene glycols, glycerin and ethylene glycol or mixtures thereof. Anti-freezing agent can be used in the range of 4% to 15% of the formulation. In one embodiment, the antifreezing agent as used herein can be polyethylene glycol, propylene glycol or a mixture thereof.

The term “anti-foaming agent” as used herein refers to a chemical agent that is added to a composition so as to prevent, mitigate, or control foam generation in the composition. Generally, non-limiting examples of anti-foaming agents include a mixture of alkenes, C11-C12, hydroformylation products, low boiling, or a commercially available product comprising it such as Geronol AF 80; a mineral oil-based defoamer or a commercially available product comprising it such as Lucrafoam® PDT; a blend of special wax, hydrophobic silica, and mineral oil or a commercially available product comprising it such as DEE FO® 3010E/50; a silicon emulsion or a commercially available product comprising it such as Silfoam® SE 47, Silfoam® SRE, Silcolapse® RG 12, and SAG 1572; a polydimethyl siloxane emulsion or a commercially available product comprising it such as SAG 10E; or a silicone-based compound or a commercially available product comprising it such as Silcolapse™ 910 and Xiameter® ACP-1000, Silcolapse™ 432, Silcolapse™ 416, SAG 1538 and the like.

The term “surfactant” as used herein refers to a chemical agent that is added to a composition in general purpose to modify, and most often reduce, the surface tension of a liquid. Depending on the nature of the hydrophilic and lipophilic groups in a surfactant molecule, surfactants can be useful as wetting agents, dispersing agents (i.e. dispersants), emulsifiers or anti-foaming agents (i.e. defoamers). Surfactants are described as anionic, non-ionic or cationic surfactants based on the chemical nature of their hydrophilic groups. Typical surfactants are described for example in McCutcheon's 2005, Volume 1: Emulsifiers and Detergents Annual, MC Publ. Co., Glen Rock, New Jersey, as well as Sisely and Wood, Encyclopedia of Surface Active Agents, Chemical Publ. Co., Inc., New York, 1964.

In certain embodiments, the anti-foaming agent comprised within the composition of the invention constitutes from about 0.5% to about 3%, e.g., from about 0.75% to about 2.5%, from about 1% to about 2%, from about 1.25% to about 1.75%, or about 1.5%, by weight of said composition.

In an embodiment, the additive is a dispersant selected from the group consisting of polyacrylates, grafted polymethylmethacrylates, ethoxylated tristypylphenol sulfonates and the mixtures thereof.

In another embodiment, the composition comprises a stabilizer selected from the group consisting of magnesium aluminum silicate, montmorillonite, smectite clay and the mixtures thereof.

In another embodiment the agrochemical composition comprises: a) 1% to 30% w/w of benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof; b) 0.5% to 4% w/w of at least one alcohol ethoxylate of formula (II) and/or (IIa); c) 1.0% to 4/0% w/w of total composition of at least one dispersant selected from the group consisting of polyacrylates, grafted polymethylmethacrylates and/or ethoxylated tristypylphenol sulfonates; d) 0.5% to 1.5% w/w of stabilizer selected from the group consisting of magnesium aluminum silicate, montmorillonite, smectite clay and the mixtures thereof.

In an embodiment, the composition comprises: a) benzoyl urea insecticidal compound selected from among a group comprising of novaluron, lufenuron, hexaflumuron, triflumuron, diflubenzuron, chlorfluazuron, flufenoxuron, noviflumuron, teflubenzuron and the mixtures thereof; b) wetting agent selected from ethoxylated alcohols of formula (II) and/or (IIa)

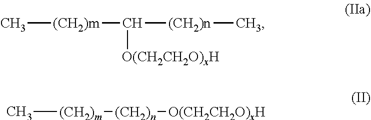

wherein 5≤x≤10, 6≤n+m≤13; and c) optionally, an additive and d) additional insecticidal agent.

In a further embodiment, an additional insecticidal agent is anthranilamide selected from among a group comprising of chlorantraniliprole, cyantraniliprole, bromantraniliprole, tetrantraniliprole and the mixtures thereof.

In certain embodiments, the amount of anthranilamide selected from among a group comprising of chlorantraniliprole, cyantraniliprole, bromantraniliprole, tetrantraniliprole and the mixtures thereof is 2% to 30% w/w of total composition.

In an embodiment, the agrochemical composition according to the invention comprising: a) benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof, b) wetting agent selected from alcohol ethoxylates of formula (II) and/or (IIa); c) optionally, an additive, d) chlorantraniliprole.

In an embodiment, the agrochemical composition according to the invention comprising: a) novaluron, b) wetting agent selected from alcohol alkoxylates of formula (II) and/or (IIa); c) optionally, an additive, d) chlorantraniliprole.

In an embodiment, the agrochemical composition according to the invention comprising: a) novaluron, b) wetting agent selected from alcohol alkoxylates of formula (IIa); c) optionally, an additive, d) chlorantraniliprole.

In an embodiment, the agrochemical composition according to the invention comprising: a) 1.0% to 30% w/w of novaluron, b) 0.5% to 4.0% w/w of wetting agent selected from alcohol alkoxylates of formula (II) and/or (IIa); c) 1.0% to 4.0% of dispersant selected from polyacrylates, grafted polymethylmethacrylates and/or ethoxylated tristypylphenol sulfonates; d) 0.5% to 1.5% w/w of stabilizer selected from the group consisting of magnesium aluminum silicate, montmorillonite, smectite clay and the mixtures thereof; e) 2.0% to 30% w/w of chlorantraniliprole.

In an embodiment, the agrochemical composition according to the invention comprising: a) 1.0% to 30% w/w of novaluron, b) 0.5% to 4.0% w/w of wetting agent selected from alcohol alkoxylates of formula (IIa); c) 1.0% to 4.0% of dispersant selected from polyacrylates, grafted polymethylmethacrylates and/or ethoxylated tristypylphenol sulfonates; d) 0.5% to 1.5% w/w of stabilizer selected from the group consisting of magnesium aluminum silicate, montmorillonite, smectite clay and the mixtures thereof; e) 2.0% to 30% w/w of chlorantraniliprole.

In an embodiment, the agrochemical composition according to the invention comprising: a) 1% to 30% w/w of novaluron, b) 0.5% to 4.0% w/w of wetting agent selected from alcohol alkoxylates of formula (II); c) 1% to 3% of dispersant selected from polyacrylates, grafted polymethylmethacrylates and/or ethoxylated tristypylphenol sulfonates; d) 0.5% to 1.5% w/w of stabilizer selected from the group consisting of magnesium aluminum silicate, montmorillonite, smectite clay and the mixtures thereof; e) 2.0% to 30% w/w of chlorantraniliprole.

In an embodiment, the agrochemical composition according to the invention comprising a) novaluron, b) wetting agent selected from alcohol alkoxylates of formula (II) and/or (IIa); c) optionally, an additive, d) cyanthraniliprole.

In an embodiment the agrochemical composition according to the invention is prepared as a suspension concentrate.

The term “suspension concentrate composition” and derivative terms such as “an insecticidal suspension concentrate composition” includes, but not limited to compositions comprising finely divided solid particles of an active ingredient/s dispersed in water or organic liquid. Said particles retain identity and can be physically separated from liquid.

### Methods of Preparation and Applying of Agrochemical Composition:

Methods for making suspensions and dispersions of particles are well known in the art and include ball-milling, bead-milling, sand-milling, colloid milling and air-milling combined with high-speed blending. The listed methods can be used in the preparation of the compositions of the present invention. This invention also relates to a method for controlling a pest comprising diluting said suspension composition with water and contacting the pest or its environment with an effective amount of said diluted composition. The preferred method for applying the diluted compositions of the present invention, such as spraying, atomizing, dispersing or pouring, will depend on the desired objectives and the given circumstances, and can be readily determined by one skilled in the art.

### Methods of Use of Agrochemical Composition:

The present invention provides method which comprises stabilizing the suspension state of benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof a) by means of b) wetting agent selected from alcohol alkoxylates of formula (II).

In some embodiments the suspension state of benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof is stabilized by means of b) wetting agent selected from alcohol alkoxylates of formula (IIa).

In an embodiment, the present invention provides the method of stabilizing the suspension state of benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof by means of the presence of from 0.5% to 4% w/w of b) wetting agent selected from alcohol alkoxylates of formula (II) based on the weight of total composition.

In an embodiment, the present invention provides the method of stabilizing the suspension state of benzoyl urea selected from among a group comprising of novaluron, lufenuron, hexaflumuron, triflumuron, diflubenzuron, chlorfluazuron, flufenoxuron, noviflumuron, teflubenzuron and the mixtures thereof by means of the presence of from 0.5% to 4% w/w of b) wetting agent selected from alcohol alkoxylates of formula (IIa) based on the weight of total composition.

In further embodiment, the suspension state of novaluron is stabilized by means of b) wetting agent selected from alcohol alkoxylates of formula (II).

In further embodiment, the suspension state of novaluron is stabilized by means of b) wetting agent selected from alcohol alkoxylates of formula (IIa).

In an embodiment, the present invention provides the method of stabilizing the suspension state of novaluron by means of the presence of from 0.5% to 4% w/w of b) wetting agent selected from alcohol alkoxylates of formula (II) based on the weight of total composition.

In an embodiment, the present invention provides the method of stabilizing the suspension state of novaluron by means of the presence of 0.5% to 4% w/w of b) wetting agent selected from alcohol alkoxylates of formula (IIa) based on the weight of total composition.

In an embodiment, the present invention provides the method which comprises stabilizing the agrochemical composition disclosed herein by means of b) wetting agent selected from alcohol alkoxylates of formula (II) and/or (IIa).

In an embodiment, the present invention provides a method for controlling pests comprising the agrochemical composition disclosed herein to a pest or the locus of said pest.

In some embodiment the locus is referred to is a field of crop.

In some embodiment said crop is selected from sugarcane, Solanaceae (e.g, tomato, eggplant), rice, corn, cotton, soybean, Brassicas (e.g, cabbage, Broccoli, Brussel sprouts, Cauliflower, Kohlrabies, Rapeseed), citrus, pome fruits, tree nuts.

In some embodiments, a pest is a plant pest. In some embodiments, said pest is referred to an insect pest selected from Lepidoptera, Coleoptera, Isoptera and Diptera species.

In a further embodiment the plant pest is selected from the group of Spodoptera frugiperda (Spodoptera spp better), Tuta Absoluta, Cnaphalocrocis medinalis, Heliothis virescens, Helicoverpa armigera, Spodoptera exigua, Plutella xylostella, Chrysodeixis includens, Cydia pomonella, Chilo suppressalis, Amyelois transitella, Pseudoplusia includens, Liriomyza sativae, Spodoptera litura, Rachiplusia nu, Helicoverpa zea.

In some embodiment the invention is referred to a method for controlling pests comprising diluting the composition disclosed herein with water to form a diluted composition and contacting the pest or a locus where control of said pest is desired with an effective amount of said diluted composition.

In some embodiment the invention is referred to a method of controlling pest comprising applying to a locus where control of said pest is desired an effective amount of the agrochemical composition disclosed herein.

The present invention also provides a method for the protection of plant propagation material from the attack by a pest such as an insect, comprising treating the propagation material or the site where the propagation material is to be planted with an effective amount of agrochemical composition disclosed herein.

### Methods of Use:

The agrochemical compositions disclosed herein are suitable for the control of undesirable vegetation, fungal pathogens, bacteria, insects or nematodes. Methods of using the agrochemical compositions of the subject invention include adding the agrochemical composition to a carrier such as water and using the resulting dispersion or solution containing the agrochemical composition for spray applications to control the insects, undesirable vegetation, fungal pathogens, or bacteria in crop or non-crop environments.

Effective application rates of the agrochemical composition cannot generally be defined, as it varies depending upon various conditions such as the type of pesticide, target pest, weather conditions, and the type of crop.

In an embodiment, the agrochemical composition is diluted in a carrier at rate from about 0.116 kg to 0.232 kg of the agrochemical composition per 1000 L of the carrier. In a further embodiment, the agrochemical composition is diluted in a carrier at a rate from about 0.116 kg to 0.150 kg of the agrochemical composition per 1000 L of the carrier. In yet another embodiment, the agrochemical composition is diluted in a carrier at a rate from about 0.150 kg to 0.232 kg of the agrochemical composition per 1000 L of the carrier. In an embodiment, the carrier is water.

### EXAMPLES

Examples according to the invention are described below, but it should not be construed that the invention is limited thereto.

### Materials and Methods

### Materials:

### Preparation of Novaluron+Chlorantraniliprole SC Composition:

### Composition 1:

| Compound | Concentration [w/w] |
|---|---|
| Chlorantraniliprole tech. (as | 13.51% |
| 100%) | |
| Novaluron Tech (as 100%) | 11.80% |
| Tergitol ™ 15-S-7 | 3.38% |
| Atlox ™ 4913 | 2.25% |
| Soprophor ® 4D/384 | 1.35% |
| Van Gel ® B | 0.81% |
| Silcolapse ®416 | 1.35% |
| Proxel ™ GXL | 0.07% |
| Propylene Glycol | 4.95% |
| AG RH 23 | 0.31% |
| Soft water | up to 100% |

### Composition 2:

| Compound | Concentration [w/w] |
|---|---|
| Chlorantraniliprole tech. (as | 10.00% |
| 100%) | |
| Novaluron Tech (as 100%) | 20.00% |
| Tergitol ™ 15-S-7 | 3.50% |
| Atlox ™ 4913 | 3.00% |
| Soprophor ® 4D/384 | 1.70% |
| Van Gel ® B | 1.00% |
| Silcolapse ® 416 | 1.00% |
| Proxel ™ GXL | 0.07% |
| Propylene Glycol | 6.50% |
| AG RH 23 | 0.31% |
| Soft water | up to 100% |

### General Preparation Procedure:

1. Soft water and Van Gel® B were charged into the vessel and the obtained mixture was stirred by means of shearing for 1 hour.
2. Atlox™ 4913, Soprophor® 4D/384, Tergitol™ 15-S-7, propylene glycol and half of total amount of anti-foam emulsion Silcolapse® 416, were added and the obtained mixture was stirred until homogenous suspension is obtained.
3. Chlorantraniliprole tech. powder was added to the previously prepared mixture with high shearing until homogenous dispersion is obtained.
4. Novaluron tech. powder was added to the previously prepared mixture with high shearing until homogenous dispersion is obtained.
5. The homogenous dispersion as previously prepared was milled until particle size range d90<9 mm obtained.
6. Proxel™ GXL and the rest of anti-foam emulsion Silcolapse® 416 were added.
7. Xanthan Gum solution AG RH 23 (2% w/w) and the rest of processing water were added, and the final composition was mixed until homogenous dispersion is obtained.

### Example 1

As a measure for the wetter efficacy, the active ingredient powder insertion time into the aqueous solution of the wetter was recorded. We further visually analyzed flowability of the wet powder and its firmness to assess the water absorption. Chlorantraniliprole and Novaluron tech. powders and the mixture of both powders (ratio 1:1) were tested.

Procedure for wetting test: Aqueous solutions of 1% wetter were freshly prepared and put in a cup, 90 g for each measurement. 10 g of active ingredient powder (Novaluron tech., Chlorantraniliprole tech. or Chlorantraniliprole 1:1 mixture) were poured at once to each wetter solution listed below. For the individual active ingredient powders the amount of time needed for active ingredients powder to insert into the water was measured and recorded. For the powder mixture the insertion to water was ranked from 1 to 5, wherein 1 represents the best wetting. Further characterization of the water absorption was assessed visually by the flowability of the wet powder and its consistency (bulky, smooth, flowable etc.)

TABLE 1
Wettability and insertion time in seconds into
aqueous solutions of different wetting agents.

| | | | Wettability |
|---|---|---|---|
| | | | [Rank 1-5] |
| | Wetting time [s] | | Chlorantraniliprole/ |
| | | Chlorantranili- | Novaluron |
| Wetter | Novaluron | prole | mixture 1:1 |
| Morwet ™ EFW | ~1200 | <45 | 3 |
| Soprophor ® | Did not insert | ~330 | Did not insert |
| 4D348 | | | |
| SOPROPHOR ® | Did not insert | ~300 | Did not insert |
| TS/16 | | | |
| Agrimer ™ | Did not insert | Did not insert | Did not insert |
| AL22 | | | |
| Emcol 4500 ™ | 120 | <45 | 1 |
| Silwet ®L77 | ~1200 | ~90 | 4 |
| Tween ® 20 | Did not insert | Did not insert | Did not insert |
| Atlas ™ G- | Did not insert | Did not insert | Did not insert |
| 5002L | | | |
| Hordaphos ® | ~600 | ~60 | 5 |
| 1306 | | | |
| Tergitol ™ 15- | ~600 | <45 | 2 |
| S-7 | | | |

As shown above in Table 1, Emcol™ 4500 and Tergitol™ 15-s-7 showed remarkably shorter insertion time for Novaluron, Chlorantraniliprole and Novaluron\Chlorantraniliprole 1:1 mixture relative to other wetting agents.

After observation of the sediment it is shown that Emcol™ 4500 remained lumpy and less flowable than Tergitol™ 15-s-7. These observations show the powder wetted on the outer surface and water not absorbed by the powder in case of Emcol™ 4500.

### Example 2

Further experiments were done to evaluate the efficacy of alcohol ethoxylates as wetting agents for Novaluron. Different ethoxylated alcohols were examined in terms of wetting time needed to moisture Novaluron, Chlorantraniliprole and Novaluron/Chlorantraniliprole 1:1 mixture.

As a measure for the wetter efficacy of selected alcohol ethoxylates we have analyzed the time for Novaluron, Chlorantraniliprole or Novaluron\Chlorantraniliprole 1:1 mixture to enter the water and the absorption of water in the particles of said active ingredients.

Procedure for wetting test: aqueous solutions of 1% wetter (alcohol ethoxylates) were freshly prepared and put in a cup, 90 g for each measurement. 10 g of active ingredient powder (Novaluron, Chlorantraniliprole and Chlorantraniliprole 1:1 mixture) were poured at once to each wetter solution listed below. The amount of time needed for active ingredients powder to insert into the water was measured. Further characterization of the water absorption was assessed visually by the flowability of the wet powder and its consistency (bulky, smooth, flowable etc.)

TABLE 2
Wetting of Novaluron, Chlorantraniliprole
and Novaluorn/Chlorntraniliprole 1:1 mixture
in different alcohol ethoxylates.

| | Wetting time [s] | | |
|---|---|---|---|
| | | | Chlorantraniliprole/ |
| | | | Novaluron |
| Wetter | Novaluron | Chlorantraniliprole | mixture 1:1 |
| Tergitol ™ | 660 | 50 | 400 |
| 15-S-7 | | | |
| Alkosynt ® | 660 | 50 | 400 |
| IT 100 | | | |
| Tergitol ™ | 90 | 50 | 210 |
| TMN6 | | | |
| Genopol ® | 210 | 50 | 720 |
| X 080 | | | |
| Lutensol ® | 660 | 50 | 400 |
| TO 8 | | | |

TABLE 3
Wetting of Novaluron in aqueous solutions of alcohol ethoxylates,
categorized by the different alcohol chains.

| | Chemical class | Wetting time [s] |
|---|---|---|
| Tergitol ™ 15-S-7 | 1-pentyl octanol (C13) | 580 |
| | 7 EO | |
| Genopol ®X 60 | isoC(13) 6 EO | 600 |
| Genopol ®ID 060 | Alcohols, iso-C9-11, | 80 |
| | C10-rich, 6 EO | |
| Luthensol ®FT XP | alpha-C(10) omega | 150 |
| 80 | hydroxy guebert | |
| | alchohol 8 EO | |
| Tergitol ™ TMN 6 | Branched Secondary | 80 |
| | Alcohol (C12) 8 EO | |
| Genopol ® ID 060 | Alcohols, iso-C9-11, | >>2000 |
| | C10-rich, 6 EO | |
| Synperonic ™ 91/6 | Linear C(8-10) 6 EO | 660 |
| LQ | | |
| Synperonic ™ 10/6 | Linear C(9-11) 6 EO | 80 |
| LQ | | |
| Genopol ® LA 070 | Linear C12-14 7 EO | >>2000 |
| Emulgator 02 NP-6 | Nonylphenol 6 EO | >>2000 |

TABLE 4
Wetting of Novaluron in aqueous solutions of isotridecyl alcohol
ethoxylates with various ethoxylation degrees. Characterization
of the ethoxylation moles needed for optimal wetting of Novaluron.

| | Chemical class | Wetting time [s] |
|---|---|---|
| Genopol ® X 50 | isoC(13) 5 EO | 1950 |
| Genopol ® X 60 | isoC(13) 6 EO | 620 |
| Genopol ® X 80 | isoC(13) 8 EO | 390 |
| Genopol ® X 100 | isoC(13) 10 EO | |
| Genopol ® X 150 | isoC(13) 15 EO | >>2000 |

As shown in Table 1-4, alcohol ethoxylates are efficient wetters for Novaluron, Chlorantraniliprole and Novaluron\Chlorantraniliprole 1:1 mixture. Further inquiry into the identity of the alcohol ethoxylate shows that 5-10 mole of ethoxylation and an aliphatic group of up to 14 carbons are significantly more effective in moisturing of tested powders than other types of surfactants. Moreover, branched and secondary alcohols showed quicker insertion into water than most other alcohol ethoxylates.

### Example 3

### Procedure for Wetting Test:

Aqueous solutions of Tergitol™ 15-s-7 were freshly prepared and put in a cup, 90 g for each measurement. 10 g of active ingredient powder (Novaluron, Chlorantraniliprole and Chlorantraniliprole 1:1 mixture) were poured at once to each wetter solution of Tergitol 15-s-7 listed below. The amount of time needed for active ingredients powder to insert into the water was measured. Further characterization of the water absorption was assessed visually by the flowability of the wet powder and its consistency (bulky, smooth, flowable etc.)

TABLE 5
The effect of Tergitol ™ 15-s-7 concentration
in water, on wetting time of Novaluron powder.

| Tergito ™I 15-s-7 | |
|---|---|
| Concentration | Wetting time [s] |
| 0.10% | did not insert |
| 0.25% | did not insert |
| 0.50% | 960 |
| 1.00% | 580 |
| 2.00% | 360 |
| 3.00% | 180 |
| 4.00% | 150 |
| 7.00% | 90 |
| 10.00% | 90 |

TABLE 6
The effect of Tergitol ™ 15-s-7 concentration in water, on wetting
time of Novaluron\Chlorantraniliprole 1:1 powder mixture.

| Tergitol ™ 15-S-7 | |
|---|---|
| Concentration [w/w] | Wetting time [s] |
| 0.10% | No insertion |
| 0.50% | 790 |
| 1% | 390 |
| 7% | 200 |

As presented in Table 5 and 6, there is a correlation between the amount of the Tergitol™ 15-s-7 and the time it takes for the Novaluron and Novaluron/Chlorantraniliprole mixture to be wetted. In this experiment it was obtained that at a concentration as low as 0.5% the ethoxylated alcohol preforms better than most wetting agents.

### Example 4

Contact angle values against parafilm surface (nonpolar organic film, modeling the leaf surface) as a function of Run No. (correlates to time) were measured for different concentrations of wetter solutions containing Emcol 4500™ and Tergitol™ 15-s-7.

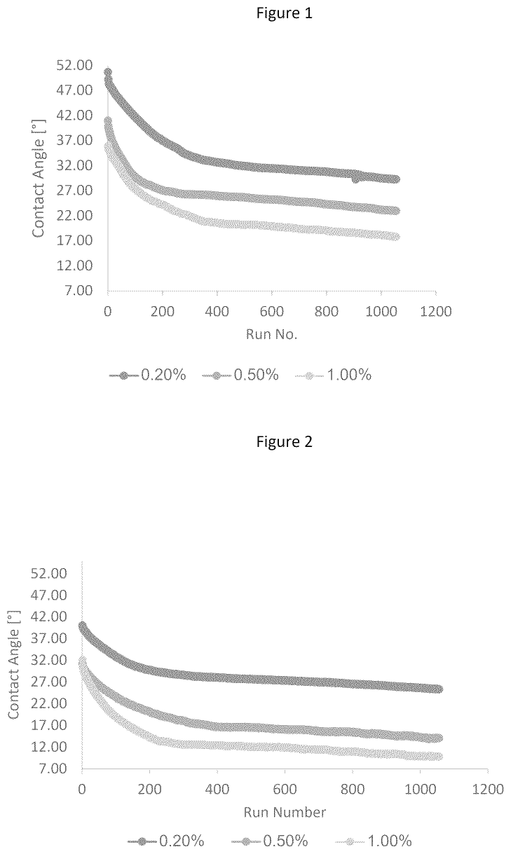

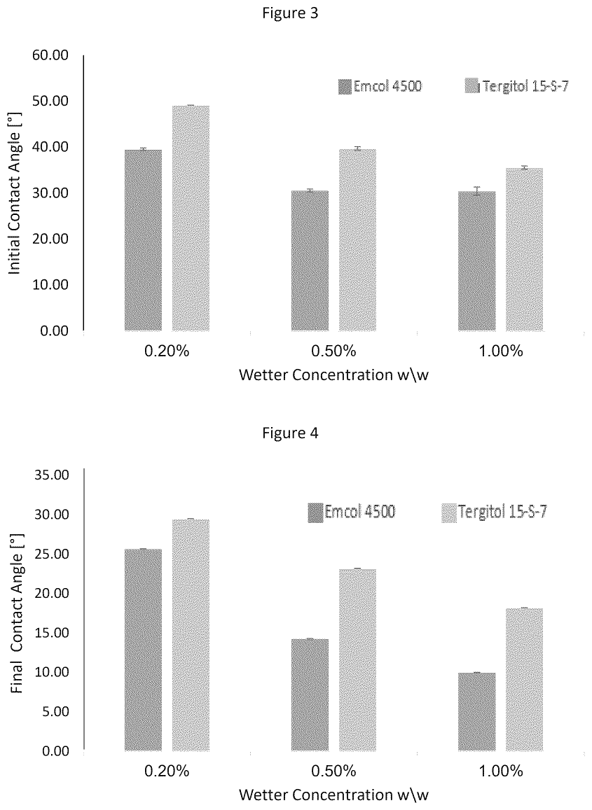

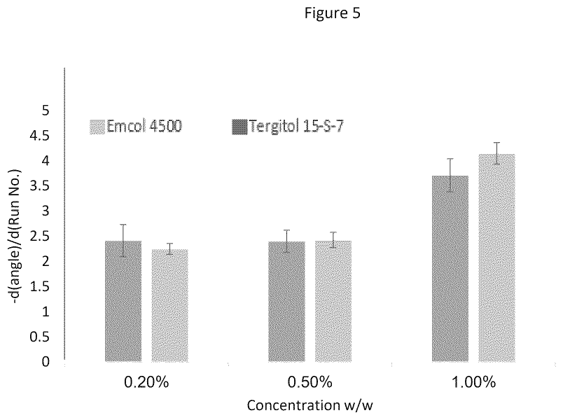

As presented on FIG. 1-5: at a given concentration Tergitol™ 15-s-7 has a higher contact angel than Emcol 4500™ and at 1% concentration the spreading rate of the droplet is larger for Emcol 4500™.

With the increase of Emcol 4500™ or Tergitol™ 15-s-7 's concentrations, the contact angle of the water droplet decreases. The experiment shows that the presence of the alcohol ethoxylate or dioctylsulfosuccinate facilitates the interaction of the water droplet with the organic nonpolar surface. It was observed that the Tergitol™ 15-s-7 shows higher initial and final angles of contact for a specific concentration. Moreover, it was shown that at a concentration of 1% the initial rate of the droplet spreading is higher for Emcol 4500™.

Thus, indicating alcohol ethoxylates will perform better as a wetter due to a good balance between the need for surface interaction between the droplet and the organic surface and the need for higher surface angle in order to use capillary forces for efficient wetting.

1. An agrochemical composition comprising:
a) a benzoyl urea insecticidal compound selected from at least one of novaluron, lufenuron, hexaflumuron, triflumuron, diflubenzuron, chlorfluazuron, flufenoxuron, noviflumuron, and teflubenzuron;
b) a wetting agent selected from ethoxylated alcohols of formula (II) and/or (IIa) 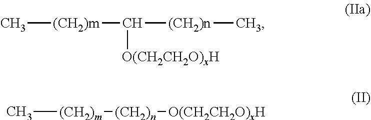
wherein 5≤x≤10, 6≤n+m≤13; and
c) optionally, an additive.

2. The composition according to claim 1, wherein the amount of wetting agent (b) is from 0.5% to 4.0% by weight of the total composition.

3. The composition of claim 1, wherein the ratio of the wetting agent b) to the benzoyl urea compound a) is from 1:24 to 1:3.

4. The composition of claim 1, wherein the wetting agent b) is a C₈-C₁₄ secondary alcohol ethoxylate having 5-10 ethylene oxide units.

5. The composition of claim 1, wherein the wetting agent b) is a C₈-C₁₄ primary alcohol ethoxylate having 5-10 ethylene oxide units.

6. The composition of claim 1, wherein the benzoyl urea a) is novaluron.

7. The composition of claim 1, wherein the benzoyl urea a) is novaluron and the wetting agent b) is a C₈-C₁₄ secondary alcohol ethoxylate having 5-10 ethylene oxide units.

8. (canceled)

9. (canceled)

10. The composition of according to claim 1, wherein the additive is a dispersant selected from the group consisting of polyacrylates, grafted polymethylmethacrylates, ethoxylated tristypylphenol sulfonates, and the mixtures thereof.

11. The composition of according to claim 1, wherein the additive is a stabilizer selected from the group consisting of magnesium aluminum silicate, montmorillonite, smectite clay, and the mixtures thereof.

12. The agrochemical composition according to claim 1, wherein the composition comprises: a) 1% to 30% w/w of the benzoyl urea; b) 0.5% to 4% w/w of at least one alcohol ethoxylate of formula (II) and/or (IIa); c) 1.0% to 4/0% w/w of the total composition of at least one dispersant selected from the group consisting of polyacrylates, grafted polymethylmethacrylates, and/or ethoxylated tristypylphenol sulfonates; d) 0.5% to 1.5% w/w of a stabilizer selected from the group consisting of magnesium aluminum silicate, montmorillonite, smectite clay, and the mixtures thereof.

13. (canceled)

14. The agrochemical composition of claim 1, further comprising at least one insecticidal agent is anthranilamide selected from chlorantraniliprole, cyantraniliprole, bromantraniliprole, tetrantraniliprole.

15. An agrochemical composition of claim 14, wherein the amount of anthranilamide is 2% to 30% w/w of the total composition.

16. An agrochemical composition comprising: a) at least one benzoyl urea selected from novaluron, lufenuron, hexaflumuron, triflumuron, diflubenzuron, chlorfluazuron, flufenoxuron, noviflumuron, and teflubenzuron, b) a wetting agent selected from alcohol ethoxylates of formula (II) and/or (IIa) as defined in claim 1; c) optionally, an additive; and d) chlorantraniliprole.

17. (canceled)

18. (canceled)

19. The agrochemical composition of claim 16, wherein the composition comprises: a) 1.0% to 30% w/w of novaluron, b) 0.5% to 4.0% w/w formula (II) and/or (IIa); c) 1.0% to 4.0% of dispersant selected from polyacrylates, grafted polymethylmethacrylates and/or ethoxylated tristypylphenol sulfonates; d) 0.5% to 1.5% w/w of a stabilizer selected from the group consisting of magnesium aluminum silicate, montmorillonite, smectite clay, and the mixtures thereof; e) 2.0% to 30% w/w of chlorantraniliprole.

20. (canceled)

21. (canceled)

22. (canceled)

23. An agrochemical composition according to claim 1, wherein the agrochemical composition is a suspension concentrate.

24. A method, comprising: stabilizing a suspension state of a benzoyl urea selected from novaluron, lufenuron, hexaflumuron, triflumuron, diflubenzuron, chlorfluazuron, flufenoxuron, noviflumuron, teflubenzuron, and the mixtures thereof by means of wetting agent selected from alcohol alkoxylates of formula (II) or (IIa) as defined in claim 1.

25. The method of claim 24, wherein the benzoyl urea is novaluron.

26. (canceled)

27. (canceled)

28. (canceled)

29. (canceled)

30. A method of controlling a pest comprising applying to a pest or a locus where control of said pest is desired an effective amount of a composition according to claim 1.

31. (canceled)

32. (canceled)

33. A method for protection of a plant propagation material from attack by a pest, comprising treating the plant propagation material or the site where the propagation material is to be planted with an effective amount of a composition according to claim 1.
